(19) United States
(12) Patent Application Publication
(10) Pub. No.: US 2014/0229026 A1
(43) Pub. Date: Aug. 14, 2014

(54) PREDICTION OF FUTURE ENERGY AND DEMAND USAGE USING HISTORICAL ENERGY AND DEMAND USAGE

(71) Applicant: Al Cabrini, New York City, NY (US)

(72) Inventor: Al Cabrini, New York City, NY (US)

(21) Appl. No.: 13/766,757

(22) Filed: Feb. 13, 2013

(51) Int. Cl. G06Q 50/06

(52) U.S. Cl. CPC G06Q 50/06
USPC 700/291

(57) ABSTRACT

A system, method, and computer program provide predicted energy and demand usage information. The information may be communicated to management in both graphical and report form. The information provides management with an immediate understanding of projected energy and demand usage in a time frame where the energy and demand usage can be associated with underlying causes. The result is that the need to devote considerable time and expertise to obtain and understand important energy consumption data are eliminated.

### CROSS-REFERENCE TO RELATED PATENT APPLICATION

This application relates to U.S. Provisional Patent Application No. 61/598,897 filed on Feb. 14, 2012, entitled PREDICTION OF FUTURE DEMAND USING HISTORICAL DEMAND USAGE, which is hereby incorporated herein in its entirety by this reference.

### FIELD OF THE INVENTION

This invention relates to the field of predicting anticipated energy consumption, for example, projected energy usage by consumers of energy such as electrical energy. By way of example, but not by way of limitation, one example of the present invention provides computer assisted prediction of energy and demand usage by energy consuming facilities based in part on historical energy and demand usage, and, more particularly, provides a prediction of energy and demand usage for a given consumer facility for a future time interval based on previous energy and demand usage by that facility and associated parameters, which may be employed in automated building management systems and energy cost control applications and/or for projecting energy costs.

### BACKGROUND OF THE INVENTION

Energy consumption is one of the key costs for various industries, for example, in the cost of operation of a manufacturing or other commercial facility. Detailed energy consumption data with time stamps may be collected by information systems, but the information is not typically readily available or presented in a manner to be quickly assimilated by management of the facility for managing energy consumption or the related costs. Nor is historical energy consumption data that has been collected typically stored for an extended period of time, for example, beyond reconciliation of the bill from the utility company to verify the amount of energy consumption for the invoiced period.

Of all the utility bills that a consumer receives each month, none, perhaps, is more difficult to decipher than the electric bill. In theory, there should be no simpler parameter to measure and bill than consumption of electricity: all the electric utility company must conceivably do is measure the consumption, multiply the measurement by an agreed-upon scheduled rate, and produce a final invoice that is clear and simple to understand.

Instead, however, the known at for producing electric utility bills is so convoluted that it often requires a separate ledger to understand what a consumer is being, asked to pay for. Currently, the electric utility company has two distinct measures according to which each commercial customer is charged: energy (measured in kWh) and demand (measured in kW). Simply put, if one imagines electricity consumption in terms of driving a motor vehicle, the energy usage (kWh) is analogous to the volume of gasoline one consumes to travel from one point to another, while the demand is the rate at which the gasoline is consumed; drive fast, and one consumes more gasoline per mile than one does if he or she simply cruises at moderate speed down the highway. The same logic applies to electric utilities: if a consumer not only uses a measurable amount of power, but uses a disproportionate portion of that power in a short amount of time, the consumer will place a large demand on the electric grid. Accordingly, to charge for energy consumption by a consumer, then, the electric utility company monitors both energy consumption and demand.

Conventional approaches to monitoring electric energy consumption generally consist of reviewing monthly electric utility bills. The conventional approach regarding electric energy consumption, compiled on a monthly basis, does not provide daily or hourly or more granular detail, and the reasons for incurring the associated costs can no longer be readily identified. The prior art does not provide a comprehensive and user-friendly view of electric energy consumption to enable control of energy consumption or estimation of energy costs.

If consumers were to periodically record periodic measurements of parameters, for example, the ambient temperatures: at, facilities operated by consumers, that, in part, determine demand usage, as well as record a corresponding measurement at demand, the consumers could create a histogram of historical demand usage relative to the measured parameters. However, the recorded measurements used to create the histogram could not be used in a meaningful manner by consumers in their automated building management systems or energy cost control applications or to predict future demand usage, because the historical data may not correlate with the current values of parameters which determine the cost of energy consumption based on demand usage since demand usage is not readily predictable based on historical data alone. For example, in a manufacturing facility, demand may depend on the amount of manufacturing equipment being operated at a given time which may vary depending on the number of orders to be filled, lighting requirements (e.g., whether the day is sunny or cloudy), what the day of the week is (e.g., a weekday versus a weekend or holiday). etc. Thus, the measurement of demand on a current basis is needed. In this regard, “smart grid” technology currently being deployed provides more current data regarding electrical energy consumption.

However, for a grid to be truly smart, one must first be able to measure and understand electrical energy consumption habits accurately, and to do that one must alter the most basic building block, which is metering. The recently introduced “smart meter” measures electricity consumption periodically, for example, at every hour or n-minute interval. The primary purpose of the smart meter is that the smart meter is linked directly to the electric utility company mainframe computer, and eliminates the need for inefficient monthly visits by electric utility company personnel to read a meter. Additionally, the smart meter may also provide consumers with analytics that would fit neatly into their existing operational models and help consumers measure current energy and demand usage as a variable to monitor energy and demand usage for managing energy consumption using, energy cost control applications and/or for projecting energy costs to fundamentally change the way consumers consume energy.

By utilizing smart meter data, one would expand the market for other, stand-alone devices and applications that consumers could apply to meet their own needs for managing energy consumption and the attendant costs. By employing smart metering technology in their operational models, consumers may more intelligently adapt to real-time pricing, at which point the devices utilized to run facilities could become truly smart and measure when the could take advantage of optimal electricity rates, directing energy consumption accordingly. Imagine, for example, having a computer assisted system that is connected to the electric utility company smart meter: as the demand usage and attendant price of electricity fluctuates throughout the day, the computer could project future energy consumption and associated costs, as well as interface to an energy cost control application, turning electrical systems and devices that consume electricity on and off accordingly, thereby optimizing production and minimizing cost.

However, the traditional method of optimizing energy management systems is by relying on instantaneous meter data. To avoid exceeding, demand, there may often be drastic compromises implemented on short notice. The demand charge often exceeds 50% of the total electric utility bill.

Accordingly, there is a need for a system and method that can acquire current energy and demand usage data on a periodic basis, as well as forecasted environmental conditions for a current date, and, additionally, can access historical data regarding energy and demand usage and associated historical data respecting environmental conditions and preferably other parameters, for a given consumer facility, to enable prediction of future energy and demand usage on current and/or future dates. Additionally, there is a need for a system and method that can interface to a building management system and an energy cost control application to manage energy and demand usage and attendant costs. Also, there is a need for a system and method that can also present a large volume of data which can be readily assimilated by management personnel and that lends to graphical presentation for monitoring electric energy consumption and related costs.

### SUMMARY OF THE INVENTION

The various examples of the present invention address the above-described challenges, with important improvements over the prior art to predict energy and demand usage, thereby enabling improved management of energy consumption and attendant energy costs resulting from predictive optimization using intraday energy and demand usage forecasting. Intraday forecasting allows prediction of energy and demand spikes and enables automated demand reduction strategies to be launched before predicted demand events occur. Additional examples of the present invention comprise interfacing with building management systems and energy cost control applications that control the operation of facilities, including manufacturing equipment, lighting, heat, air conditioning, and ventilation (HVAC) equipment, etc. In accordance with further examples of the present invention, reporting is made accessible for visualization by management, for example, managers in a variety of commercial businesses monitoring predicted energy and demand usage on a substantially current basis and to provide a view of projected energy and demand usage, as well as the capability to present associated energy consumption costs for visualization.

Accordingly, a system, method, and computer program in accordance with one example embodiment of the present invention provide an intraday forecast energy and demand usage for a given consumer facility, which is computed periodically, for example, every quarter hour, employing smart meter measurements, historical data for energy and demand usage by the given facility, historical environmental data associated to the historical energy and demand usage, and current energy and demand usage and forecasted environmental data to enable predictive optimization of energy and demand usage. The predicted energy and demand usage may additionally be presented in graphical form. The graphical presentation and additional reports respecting the predicted energy and demand usage may be employed to identify the timing and extent of energy consumption and attendant costs. The graphical presentation of the information provides management with an immediate understanding of predicted energy and demand usage in a time frame where costs can be associated to projected energy consumption, thereby enabling, improved operational planning.

One example embodiment of the present invention is preferably implemented by a fully automated software application providing computation of predicted energy and demand usage on a periodic basis (e.g., daily or hourly or even at fractions of an hour as compared to a billing period). Preferably, the frequency of the computations is user defined. After computation, for example, every quarter hour, the entire process from prediction of energy and demand usage to development of graphical presentations and or reports and email distribution and exporting data to building management systems and energy cost control applications may be fully automated. Each graphical presentation or report set can be sent according to separate email distribution lists,

The software prediction application can be configured to acquire data related to energy and demand usage at relatively frequent periods to provide a granular visualization of energy and demand usage. The software prediction may employ a nonlinear regression technique to project energy and demand usage. Additionally, the current energy and demand usage data and other parameters associated to the current energy and demand usage (e.g., current ambient environmental data can be stored in a database so that data is accumulated to enhance the precision of the software prediction application. This in turn enables building management s stems and energy cost control applications to be optimized for controlling the operation of facilities and rein in operating costs related to energy consumption.

The foregoing and other objects features, and advantages or the present invention will become more readily apparent from the following detailed description of various example embodiments of the present invention, which proceeds with reference to the accompanying drawing.

### BRIEF DESCRIPTION OF THE DRAWING

The various example embodiments of the present invention will be described in conjunction with the accompanying figures of the drawing to facilitate an understanding of the present invention. In the figures, like reference numerals refer to like elements. In the drawing:

FIG. 1 is a schematic drawing of a hardware platform for implementation of the system in accordance with one example embodiment of the present invention.

FIG. 2 is schematic drawing of an alternative hardware platform for implementation of the system in accordance with another example embodiment of the present invention.

FIG. 3 illustrates the basic process flow of the method for predicting the energy and demand usage and creating a graphical presentation and report for distribution in accordance with one example embodiment of the present invention.

FIG. 4 is schematic drawing et an alternative hardware platform for implementation of the system in accordance with a further example embodiment of the present invention.

FIG. 5 shows an example of a graph of predicted energy consumption and demand measured in watts in accordance with one example embodiment of the present invention.

### DETAILED DESCRIPTION OF EXAMPLE EMBODIMENTS

Various example embodiments of the present invention provide a system and method for generating predicted energy and demand usage data and periodic graphs and/or reports for visualization of the predicted energy and demand usage data and distribution of the predicted data. For example, these are valuable in helping managers of consumers to identify the predicted energy and demand usage and associated cost of energy consumption.

One aspect of the present invention provides periodic computation of energy and demand usage. Another aspect provides a graphical presentation of energy and demand usage and as plurality of reporting options. Another aspect of the present invention provides computer instructions stored on or in a computer-readable medium and capable of being executed by a processor to implement the desired periodic energy and demand usage computations and automate the creation of graphs and optional reports and distribution to recipients, for example, via email.

One example of the present invention is particularly applicable to a computer implemented software based electric energy consumption monitoring and management system to provide predicted energy and demand usage, it is in this context that the various example embodiments of the present invention will be described. It will be appreciated, however, that the system and method for providing monitoring and management based on the predicted energy and demand usage in accordance with the present invention have greater utility, since they may be implemented in hardware or may incorporate other modules or functionality not described herein.

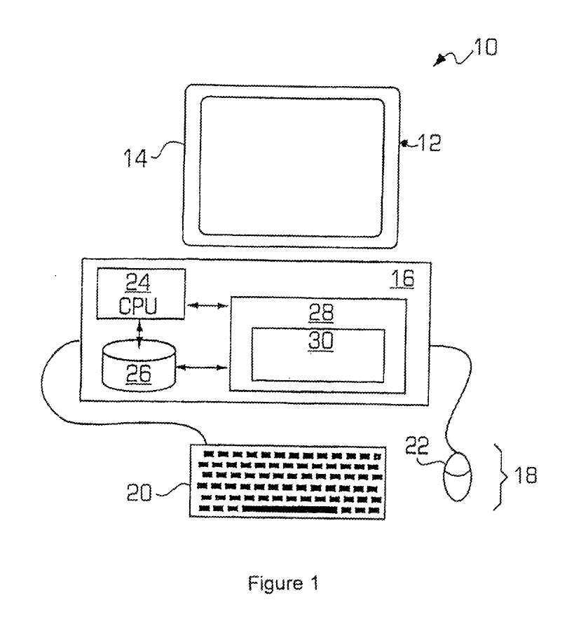

Referring now to the drawing, FIG. 1 a block diagram illustrating an example of a system 10 for computing predicted energy and demand usage in accordance with one example embodiment of the present invention implemented on a personal computer 12. In particular, the personal computer 12 may include a display unit 4 which may be a cathode ray tube (CRT), a liquid crystal display, or the like; a processing unit 16; and one or more input/output devices 18 that permit a user to interact with the software application being executed by the personal computer. In the illustrated example, the input/output devices 18 may include a keyboard 20 and a mouse 22, but may also include other peripheral devices, such as printers, scanners, and the like. The processing unit 16 may further include a central processing unit (CPU) 24 (e.g., an Intel Duo-Core 2.4 GHz and 4 GB of RAM), a persistent storage device 26, such as a hard disk, a tape drive, an optical disk system, a removable disk system, or the like, and a memory 28. The CPU 24 may control the persistent storage device 26 and memory 28. Typically, a software application may be permanently stored in the persistent storage device 26 and then may be loaded into the memory 28 when the software application is to be executed by the CPU 24. In the example shown, the memory 28 may contain an energy and demand usage prediction computation tool 30 for prediction of energy and demand usage to enable monitoring acid management of electric energy consumption. The energy and demand usage prediction computation tool 30 may be implemented as one or more software modules that are executed by the CPU 24.

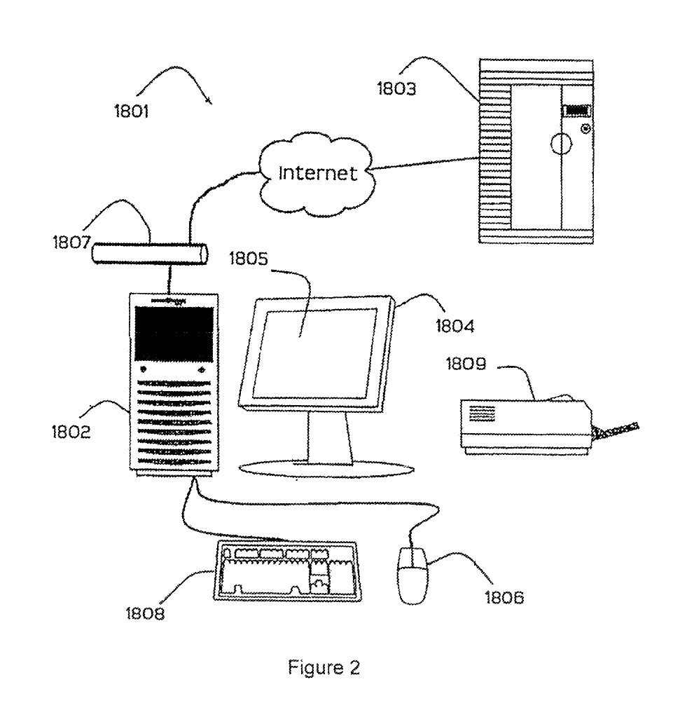

In accordance with other various contemplated example embodiments or the present invention, the system 10 may also be implemented using hardware and may he implemented on different types of computer systems, such as client/server systems, Web servers, mainframe computers, workstations, and the like. Thus, in accordance with another example embodiment of the present invention, the system 10 may be implemented via a hosted Web server. A system using a hosted Web server, generally indicated by the numeral 1801, is shown in FIG. 2. The system 1801 preferably comprises a Web-based application accessed by a personal computer 1802, as shown in FIG. 2. For example, the personal computer 1802 may be any personal computer having at least two gigabytes of random access memory (RAM), and using a Web browser, preferably MICROSOFT Internet Explorer 6.0 browser or greater available from Microsoft Corporation located in Redmond, Wash.

In the illustrated example, the system 1801 is a 128-bit SSL encrypted secure application running on a MICROSOFT Windows Server 2003 operating system or Windows Server 2000 operating system or later operating system available from Microsoft Corporation. The personal computer 1802 also comprises a hard disk drive preferably having at least 40 gigabytes of free storage space available. The personal computer 1802 is coupled to a network 1807. For example, the network 1807 may be implemented using an Internet connection. In one implementation of the system 1801, the personal computer 1802 can be ported to the Internet or Web, and hosted by a server 1803. The network 1807 may be implemented using, a broadband data connection, such as, for example, a DSL, or greater connection, and is preferably all or faster connection. The graphical user interface of the system 1801 is preferably displayed on a monitor 1804 connected to the personal computer 1802. The monitor 1804 comprises a screen 1805 for displaying the graphical user interface provided by the system 1801. The monitor 1804 may be a 15″ color monitor and is preferably a 1024×768, 24-bit (16 million colors) VGA monitor or better. The personal computer 1802 further comprises a 256 or more color graphics video card installed in the personal computer. As shown in FIG. 2, a mouse 1806 is provided for mouse-driven navigation between screens or windows comprising the graphical user interface of the system 1801. The personal computer 1802 is also preferably connected to a keyboard 1808. The mouse 1806 and keyboard 1808 enable a user utilizing the system 1801 to compute periodic prediction of energy and demand usage. Preferably, the user can prim the results using a printer 1809. The system 1801 is implemented as a Web-based application, and data may be shared with additional software (e.g., a word processor, spreadsheet, or any other business application). Persons skilled in the art will appreciate that the systems and techniques described herein are applicable to a wide array of business and personal applications.

In accordance with one example embodiment of the method of the present invention, a prediction of energy and demand usage is produced. The predicted energy and demand usage are computed using historical and current values of energy and demand usage and additional parameters.

The additional parameters include the historical energy and demand usage of the consumer facility for which the predicted energy and demand usage are to be computed. The historical energy and demand usage liar the given facility can be obtained using past (i.e., historical) energy and demand usage for the facility stored in the memory of a computer or in a database maintained by the consumer and accessible by the computer or from the electric utility. Preferably, the stored historical energy and demand usage data relate to measurements of energy and demand usage on prior dates (i.e., day and year) and preferably at predetermined intervals of time, for example, every quarter hour. However, if the historical energy and demand usage measurements are at greater intervals of time, the energy and demand usage data can be interpolated to provide the energy and demand usage data needed to compute a predicted energy and demand usage.

The additional parameters needed to predict the energy and demand usage for the given facility also comprise the historical ambient environmental conditions for the given consumer facility associated to the stored historical energy and demand usage data. That is, each datum of stored historical energy and demand usage data has ambient environmental data associated thereto. The historical ambient environmental data for the given facility can be obtained using past (i.e., historical) environmental data for the facility stored in the memory of the computer or in the database maintained by the consumer and accessible by the computer or from the National Weather Service archives. Preferably, the stored historical ambient environmental data relates to measurements of environmental conditions at predetermined intervals of time, for example, every quarter hour. However, if the historical ambient environmental data measurements are at greater intervals of time, the environmental condition data can be interpolated to provide the ambient environmental data needed to compute an energy and demand usage prediction. Fundamentally, the historical environmental data comprises the temperature on prior dates (i.e., day and year) at predetermined intervals of time. Preferably, the historical environmental data additionally comprises data respecting cloud conditions clear, partly sunny, partly cloudy, cloudy, etc.) on prior dates (i.e., day and year) at short intervals of time. The historical ambient condition data may also comprise additional ambient environmental conditions, bar example, the wind velocity (i.e., direction and magnitude), dew point temperature, type of precipitation, if any, (e.g., rain, sleet, snow, etc.) and amount inches) on prior dates (i.e., day and year) at short intervals of time. These ambient environmental conditions of affect energy and demand usage, for example, the amount of lighting and HVAC needed to operate the given consumer facility. For example, energy and demand usage due to lighting and heating needs are typically greater on a cold cloudy winter day than on a warm sunny spring day. By way of further example, demand usage due to air conditioning needs is typically greater in the summer than in the winter.

Additional data that is preferably associated to the historical ambient environmental data may comprise whether the date falls on a weekend or a holiday, or whether an exception event, for example, a power failure, equipment malfunction, scheduled maintenance, labor disruption, or other atypical situation occurred on the date. These exception events affect the demand usage on the effected date. In the case of manufacturing and/or assembly plant, the additional data also preferably comprise the percentage of production capacity used on that date.

The additional parameters needed to predict the energy and demand usage for the given facility also comprise the current and forecast ambient environmental conditions far the given consumer facility for the current date. The current ambient environmental data preferably comprise the same measurements included in the historical ambient environmental data measured at predetermined intervals for the portion of the day that has elapsed. The forecast ambient environmental data are the projected ambient environmental data that can be obtained from the National Weather Service, for example, at http://forcast.weather.gov/zipcity.php.

Accordingly, the predicted energy and demand (PD) usage can be computed as follows. An important task in statistics is to find the relationships, if any, that exist in a set of variables when at least one is random, being subject to random fluctuations and possibly measurement error. In regression problems, typically one of the variables, often called the “response” or dependent variable is of particular interest, for example, PD (energy usage can be similarly computed). The other variables x₁, x₂, . . . , xₖ, usually called “explanatory”, “regressor”, or independent variables, here consist of the historical and current demand usage associated to the historical and current ambient environmental data, and are primarily used to predict or explain the behavior of the response, PD. If plots of the data suggest some relationship between PD and the xₖ's, then the relationship can be expressed via some function ƒ, namely,

PD=ƒ(x₁, x₂, . . . , xₖ).

Nonlinear regression analysis can then be used to process the data to compute the PD for a subsequent interval of time. In one example, the prediction may be based on the historical demand usage, historical ambient temperature, and predicted ambient temperature for the next 24 hours. The consumer facility characteristics (frame, concrete, glass, etc.) and all the assets (brand, age, output, etc.) are all factored in as part of the demand usage data A nonlinear regression analysis may then be performed to develop a statistical model to predict 15-minute-interval demand usage for the next 24 hours. The prediction of demand usage adjusts (skewed) based on the actual usage. In other words, the actual demand usage from 6:00 AM to 8:00 AM, for example, will impact and adjusts the initial predicted demand usage for 2:00 PM to 4:00 PM.

In another example, at the end of a given day T, the nonlinear regression model can analyze three-month historical electricity demand usage for a given consumer facility and compute demand forecasts for day T+1 (e.g., for each 15-minute interval) using Principal Component Analysis. Moreover, the model is preferably able to effectively respond to real-time electricity demand usage information in early hours of day T+1 by updating the demand forecasts later hours on the same day. The predicted demand usage computed by the model can therefore be used to take preemptive actions to reduce demand and save energy.

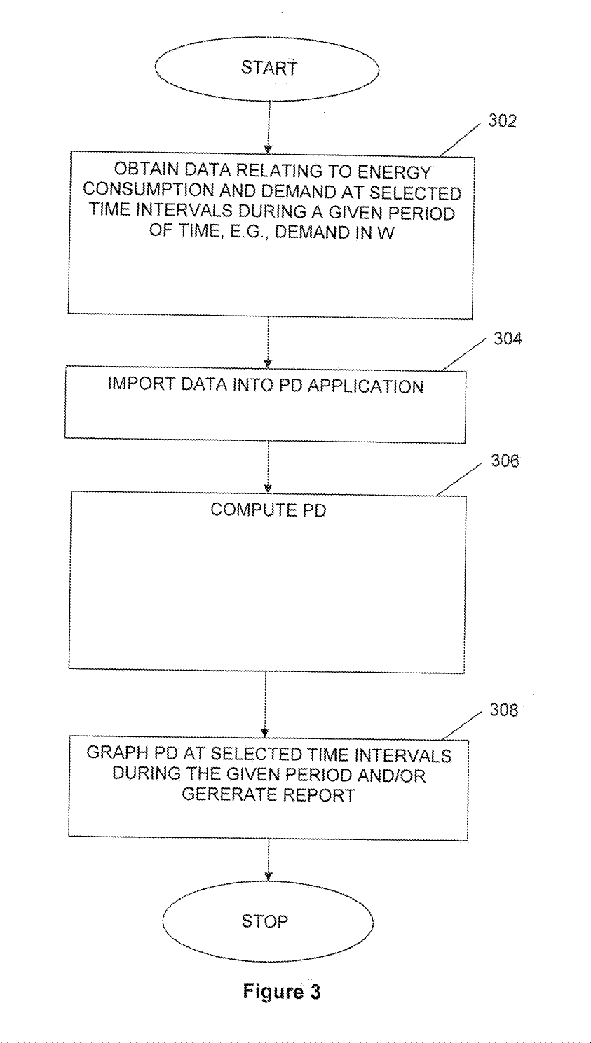

FIG. 3 shows the processing flow for the predicted demand application software in accordance with one computer implemented example embodiment of the present invention. Periodic prediction of demand (PD) may be performed at periodic intervals during a day, as will be described in more detail below and may span the period of a portion of or the entire day, for example. For example, data may be obtained during the period or a day, that is, over a 24-hour period. Data for the power usage are obtained from a metering information system (e.g., a smart meter system) as indicated by a step 302 shown in FIG. 3. For example, the data are demand in watts (W) in the example of electric energy consumption. In order to predict demand, the measured power usage is averaged over a predetermined interval of time. For example, the averaging can be performed at n-minute intervals, for example, each quarter hour (i.e., 15 minutes), or even more granular intervals of time. The data is imported into the predicted demand application, as indicated by a step 304 shown in FIG. 3, were the data is utilized for subsequent processing. The predicted demand is then computed using nonlinear regression analysis, as indicated by a step 306 shown in FIG. 3. Nonlinear regression analysis software applications that can be employed to accurately forecast both energy (kWh) and demand (kW) are commercially available, for example, NLREG available at http://www.nlreg.com/index.htm. Following computation of the predicted demand, a graph of demand usage including the predicted demand may be generated and/or a corresponding report may be generated, for example, as documents in Adobe Acrobat or other format, as indicated by a step 308 shown in FIG. 3. In a contemplated modification of the example method shown in FIG. 3, email addresses may be obtained for distribution of the demand usage including the predicted demand. Finally, emails with graphical presentation and/or report attachments may then be created and sent to those responsible for managing the energy consumption of the consumer.

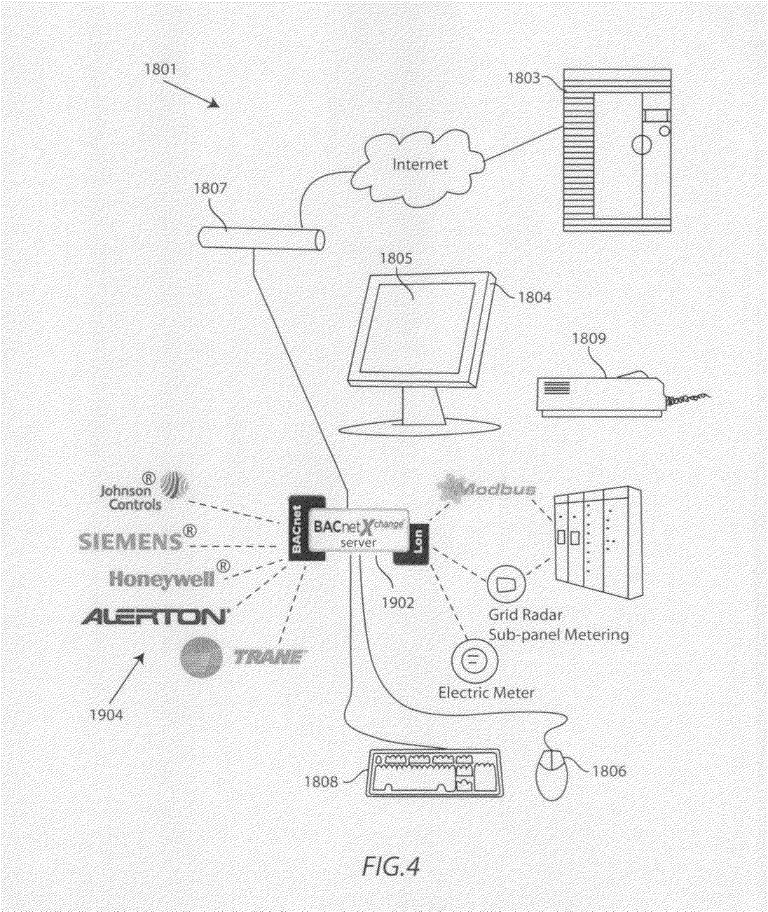

In a further example, the example embodiment shown in FIG. 2 can be modified to interface to one or more building management systems at a consumer facility, as shown in FIG. 4. The personal computer 1802 shown in FIG. 2 is replaced by a server 1902 that interfaces to one or more building management systems 1904 which implement predictive optimization strategies. Examples of building management systems 1904 include building management systems for large consumer facilities commercially available from Johnson Controls, Siemens, Honeywell, Alerton, and Trane. The building management systems 1904 also include automation systems for small consumer facilities, for example, the GridNavigator building automation system that comprises thermostats, lighting control systems, and sub-metering. In accordance with the example embodiment shown in FIG. 4, the predictive optimization routines of the building management systems 1904 are provided with intraday energy and demand usage forecast data to more effectively control energy and demand usage. Enhanced predictive optimization results from use of the intraday energy and demand forecast data service as a tool to program the predictive optimization routines employed by the building management systems 1904. The predictive optimization routines utilize the forecast data, thereby lowering the energy usage and capping the demand and budgeting the demand high water mark. Whereas engineers have previously been coding, the predictive optimization routines for building management systems with limited success in managing energy and demand usage, the intraday enemy and demand forecast data service improves the results achieved, by the predictive optimization routines and makes them more powerful. The server 1902 functions as an “aggregator” that communicates using the major well-known protocols of BACnet/IP, Lon, and Modbus, as well as many proprietary protocols. A typical consumer facility uses more than one such protocol, and it is difficult to consolidate end-points together. The server 1902 provides a bi-directional gateway to aggregate BACnet/IP, Lon, and Modhus points, for example, from one or more building management systems 1904 at the consumer facility and communicates with the server 1803 at a centralized cloud data center. The server 1902 gathers energy data in real-time and analyzes and communicates the data to the server 1803. Additionally, the server 1902 delivers forecast energy and demand data to the one or more building, management systems 1904 interfaced to the server 1902 from the secure cloud-based service provided by the server 1803, thereby providing an intraday energy forecast data service. The consumer facility uses the intraday forecasted energy and demand data to implement automated predictive optimization strategies that result in energy and demand reduction through operation of the one or more building management systems 1904. The server 1902 solves the problem of consolidating the end-points together, irrespective of what building management system or systems is/are used, by seamlessly integrating with the one or more building management systems to exchange end-points from multiple protocols. For example, the energy usage (kWh) can be forecast every hour and demand (kW) can be predicted at 15-minute intervals and a preselected number of BACnet points can be populated via the interface to the one or more building management systems 1904 that results in more effective predictive optimization of electrical energy and demand usage at the consumer facility. Additionally, reports can be designed and generated remotely from the cloud based data center and sent to those responsible for managing the energy consumption at the consumer facility. The data can also be exported to energy cost control applications employed at the consumer facility.

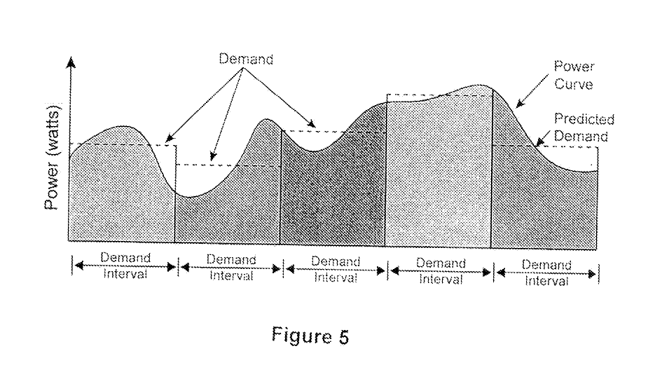

Considered in more detail, costs related to electrical energy consumption are better understood and anticipated by observing and analyzing the graph shown in FIG. 5. FIG. 5 is a graph of electrical demand measured in watts (W) during a period of time measured at given intervals, for example, quarter-hour intervals. Demand is defined as the average watts over a specified time interval. The average can include, positive and negative power, and the reported demand may be positive or negative. However, negative demand should only occur with net metering or when energy is being generated. A typical demand interval, is 15 minutes. The meter records the peak demand with a time stamp for metering applications where the measurements may only be accessed weekly or monthly. The meter synchronizes demand measurements to the time-of-day, so, for example, if the demand period is 15 minutes, demand measurements will complete at 11:00 AM, 11:15 AM, 11:30 AM, etc. If the meter clock is changed (say from 1:59 AM to 3:00 AM because of the switch to daylight savings time), the meter will find the next synchronized time (3:15 AM in the present example) to complete the demand measurement, so that the demand period is as close as possible to the target demand period.

The graph shown in FIG. 5 includes predicted demand (PD) in accordance with the example embodiment of the method of the present invention for the subsequent given time interval, as shown in FIG. 5. Employing the predicted demand, consumers are able to radically improve their operating performance: with a smart metering system measuring demand on a quarter-hour basis, for example, and able to identify the inputs and outputs of each part of a production plant, for example, consumers are able to predict demand and optimize energy usage accordingly.

The graph including predicted demand shown in FIG. 5 demonstrates the advantages of the example embodiment of the method of the present invention. FIG. 5 illustrates an important view of demand for management to immediately assess potential areas of concern that can then be examined in more detail and/or utilized to manage energy consumption using the illustrated graph. Consider, for example, a hospital. An X-ray department, for example, may consume as much electrical, energy as the rest of the entire facility in which the X-ray department is located. Each department in the facility may be charged differently: one (the X-ray department) draws power in short, intense bursts, and the other departments do so steadily over the course of the day. Employing the predicted demand graph, including the predicted demand, shown in FIG. 5 or a corresponding report, for example, sent by email would enable a hospital administrator to see the predicted demand, and enable him or her to allocate resources accordingly and act to optimize electric energy consumption globally. The predicted demand provides a powerful monitoring capability, far superior to the prior art. The overall graph provides an important advance versus the prior art, providing a graphical view of demand and predicted demand that can immediately convey the timing and extent of recent and projected electricity consumption and related costs.

Or, as another example, consider a college, campus: the building that houses the chiller, for example, may draw the same amount of power as another building, but the charge for each building is different, given the intensity (demand). To surface the projected cost, and control the grid to maximize efficiency, the graph including the predicted demand shown in FIG. 5 can be employed. In accordance with one example implementation of the system and method in accordance with the present invention, intraday energy forecasting allowed a community college to achieve an additional electrical energy savings and a 7-10% demand reduction.

While the foregoing description has been with reference to particular example embodiments and contemplated alternative embodiments of the present invention, it will be appreciated by those skilled in the art that change may be made without departing from the principles and spirit of the invention. In accordance with the example embodiments, an electric energy consumption application has been described. However, the principles of the present invention apply more generally. The invention would also have application in other energy usage applications, for example, natural gas consumption. Accordingly, the scope of the present invention can only be ascertained with reference to the appended claims.

What is claimed is:

1. A method for predicting demand on a periodic basis, comprising:
obtaining data comprising measured demand at a consumer facility at selected time intervals during a given period of time from an external information system;
importing the data from the external information system;
computing predicted demand using the imported data; and
producing an output of the computed predicted demand.

2. The method of claim 1 wherein the imported data further comprise historical energy and demand usage data for the consumer facility.

3. The method of claim 2 wherein the imported data further comprise historical ambient environmental condition data for the consumer facility associated to the historical energy and demand usage data.

4. The method of claim 3 wherein the historical ambient environmental condition data for the facility are stored in a database maintained by the consumer or from National Weather Service archives.

5. The method of claim 4 wherein the historical ambient environmental condition data comprise temperatures on prior dates at predetermined intervals of time; data respecting cloud conditions on the prior dates in the predetermined intervals of time; wind velocity on the prior dates at the predetermined intervals of time; dew point temperatures on the prior dates at the predetermined intervals of time; and types of precipitation, if any, and amounts on the prior dates at the predetermined intervals of time

6. The method of claim 5 wherein the imported data further comprise data associated to the historical ambient environmental condition data comprising whether the prior dates fall on a weekend or a holiday and whether an exception event comprising a power failure, equipment malfunction, scheduled maintenance, or labor disruption occurred on the prior dates.

7. The method of claim 1 wherein the imported data further comprise the current and forecast ambient environmental conditions for the consumer facility for a current date.

8. The method of claim 1 wherein the forecast ambient environmental data are projected ambient environmental data obtained from the National Weather Service.

9. The method of claim 1 wherein, the predicted demand is computed using nonlinear regression analysis.

10. The method of claim 1, further comprising computing predicted energy usage.

11. A system to predict demand on a periodic basis, comprising:
an external information system to obtain data comprising measured demand at a consumer facility at selected time intervals during a given period of time;
an interface to import the data from the external information system;
a computing system comprising a processor to compute predicted demand using the imported data; and
a communication system to output the predicted demand.

12. The system of claim 11 wherein the imported data further comprise historical energy and demand usage for the consumer facility.

13. The system of claim 12 wherein the imported data further comprise historical ambient environmental condition data for the consumer facility associated to the historical energy and demand usage data.

14. The system of claim 13 wherein the historical ambient environmental condition data for the facility are stored in a database maintained by the consumer or from National Weather Service archives.

15. The system of claim 14 wherein the historical ambient environmental condition data comprise temperatures on poor dates at predetermined intervals or time; data respecting cloud conditions on the prior dates at the predetermined intervals of time wind velocities on the prior dates at the predetermined intervals of time; dew point temperatures on the prior dates at the predetermined intervals of time; and types of precipitation, if any, and amounts on the prior dates at the predetermined intervals of time.

16. The system of claim 15 wherein the imported data further comprise data associated to the historical ambient environmental condition data comprising whether the prior dates fall on a weekend or a holiday and whether an exception event comprising a power failure, equipment malfunction, scheduled maintenance, or labor disruption occurred on the prior dates.

17. The system of claim 16 wherein the imported data further comprise the current and forecast ambient environmental conditions for the consumer facility for a current date.

18. The system of claim 11 wherein the forecast ambient environmental data are projected ambient environmental data obtained from the National Weather Service.

19. The system of claim 11 wherein the predicted demand is computed using nonlinear regression analysis.

20. The system of claim 11 wherein the computing system computes predicted energy usage.
